(19) United States
(12) Patent Application Publication
(10) Pub. No.: US 2012/0133742 A1
(43) Pub. Date: May 31, 2012

(54) GENERATING A TOTAL DATA SET

(75) Inventor: Thomas Ertl, Florstadt (DE)

(73) Assignee: DEGUDENT GMBH, Hanau (DE)

(21) Appl. No.: 13/386,845

(22) PCT Filed: Jul. 8, 2010
(86) PCT No.: PCT/EP2010/059819

§ 371 Date: Feb. 2, 2012

(30) Foreign Application Priority Data
Jul. 24, 2009 (DE) 10 2009 026 248.2

(51) Int. Cl. H04N 13/02

(52) U.S. Cl. 348/46; 348/E13.074

(57) ABSTRACT

The invention relates to generating a total data set of at least one segment of an object for determining at least one characteristic by merging individual data sets determined by means of an optical sensor moving relative to the object and of an image processor, wherein individual data sets of sequential images of the object contain redundant data that are matched for merging the individual data sets. In order that the data obtained by scanning the object are of sufficient quantity for performing an optimal analysis, but without being too great an amount of data for processing, the invention proposes that individual data sets determined per unit of time be varied as a function of the relative motion between the optical sensor and the object.

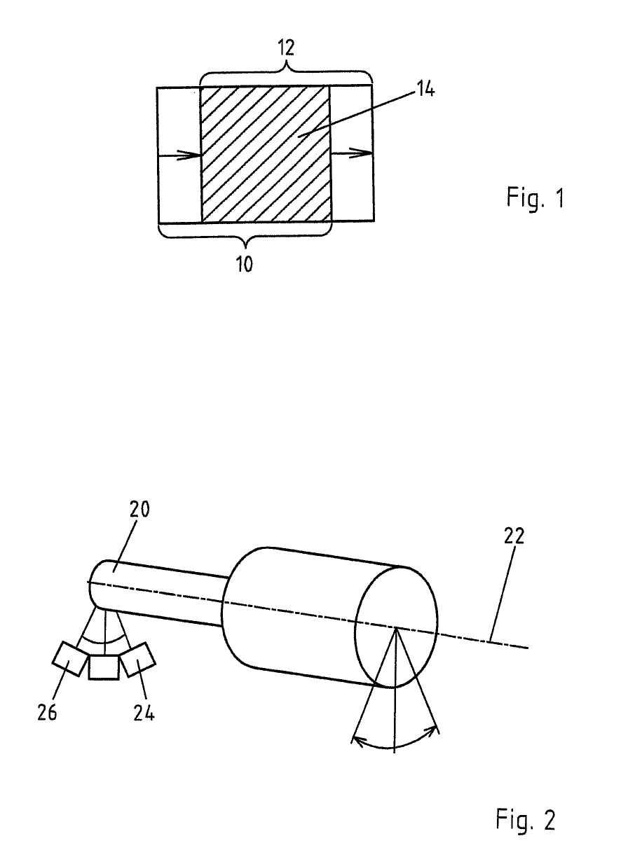

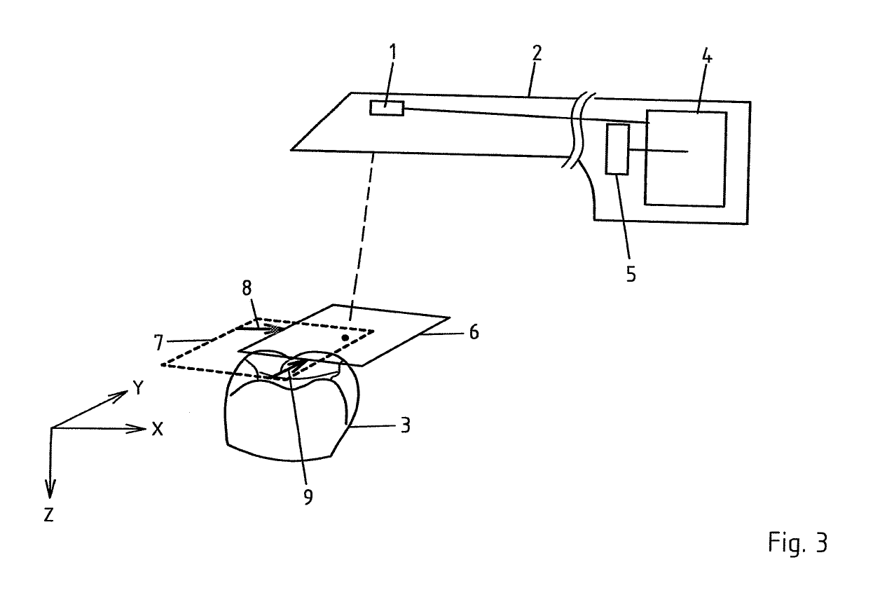

The invention relates to the generation of an aggregate data set of at least one section of an object, such as a section of a jaw, for the purpose of determining at least one characteristic feature, such as shape or position, by merging individual data sets, which are acquired by means of an optical sensor, such as a 3D camera, that is moving relative to the object and an image processing system, whereby individual data sets of consecutive images of the object contain redundant data, which are matched to combine the individual data sets.

Intraoral scanning of a jaw region can be used to generate 3D data that can form the basis for the manufacture of a dental prosthesis in a CAD/CAM process. However, during intraoral scanning of teeth the visible portion of a tooth or jaw section, from which the 3D data are measured, is usually much smaller than the entire tooth or jaw, so that it becomes necessary to combine several images or the data derived from these to form an aggregate data set of the tooth or jaw section.

Optical sensors, e.g. 3D cameras, usually are guided manually in order to acquire the relevant regions of a jaw section in a continuous manner, so that subsequently an image processor can use the individual images to generate 3D data, from which subsequently an aggregate data set is created. Since the movement is performed by hand, it can not be ensured that sufficient data is available if the sensor is moved rapidly. If the sensor is moved too slowly, one obtains too many redundant data in certain areas of the object. Redundant data is data that results from the overlap of successive images, i.e. redundant data is the data generated in the overlap region.

In order to eliminate these risk factors, one requires a high constant frame rate to be able to obtain sufficient data with adequate overlap factor of the individual data sets even in cases of rapid movements. This results in the need for costly electronics with high bandwidth and high memory requirements.

US-A-2006/0093206 discloses a method for determining a 3D data set from 2D point clouds. An object such as a tooth is scanned, whereby the frame rate is dependent on the speed of the scanner that is used to acquire the images.

US-A-2006/0212260 refers to a method for scanning an intraoral hollow space. The distance between a scanning device and a region to be measured is taken into account during the evaluation of the data sets.

Subject matter of U.S. Pat. No. B-6,542,249 are a method and a device for the three-dimensional contact-free scanning of objects. Overlapping individual images are used to obtain 3D data of a surface.

A generic method is described in US-A-2007/0276184. An endoscope is inserted into a bodily orifice. A stationary sensor that detects markings on the endoscope is provided for the purpose of determining the movement of the endoscope.

For the 3-dimensional measurement of a jaw region, US-A-2006/0228010 discloses a scanner with a frame rate that is controlled in dependence on a preset rate of a flash, which is used to illuminate the jaw region.

For the purpose of recording blur-free images using the vehicle of a toy system, US-A-2009/0004948 describes markings arranged along a travel track that are used to determine the velocity. The frame rate is varied in dependence on the velocity.

It is the objective of the present invention to further develop a method of the above-mentioned type in a way so that the data obtained during the scanning of the object are present in a sufficient quantity to allow an optimal evaluation, without the need to process an unnecessarily large amount of data, which would require expensive electronics with high bandwidth and large memory capacity.

To meet this objective, the invention substantially intends that a 3D camera be used as optical sensor, and that data sets acquired per time interval be varied in dependence on the relative movement between the optical sensor and the object, whereby for determining the relative movement, the first sensor comprises one second sensor selected out of the group consisting of an acceleration sensor, a rotation sensor, and an inertial platform, or that the number of individual data sets to be acquired per time interval be controlled in dependence on the number of redundant data of consecutive data sets.

In accordance with the invention, it is intended that the data acquisition rate be varied in dependence on the relative motion between the optical sensor and the object. The individual data sets are obtained in a discontinuous manner. This means that the frame rate during the scanning process is not constant but parameter-dependent. Parameter-dependent here means that parameters, for example relative velocity between the object and the optical sensor and/or distance between the sensor and the object to be measured and/or overlap factor of two successive images, are taken into account.

In particular it is intended that the number of individual data sets to be determined per time interval be varied in dependence on the number of redundant data of consecutive data sets. However, it is also possible to control the number of individual data sets to be acquired in dependence on the relative speed between the object and the optical sensor.

However, the invention does not rule out the concept of omitting redundant images with a high overlap factor from the registration process after an acquisition with continuously high data rate. This however does not completely solve the problem of high bandwidth requirements during the data acquisition.

For this reason the invention in particular intends that trailing changes to the data acquisition rate not be performed, as would be the case for a control system utilizing the current overlap factor in a real-time registration process, since the overlap factor can only be computed from two or more consecutive data sets.

Since any dependence on the number of individual data sets per time interval is dependent upon the relative movement between the optical sensor and the object, the motion of the object will be taken into account in addition to the motion of the sensor. The motion of the object can be determined by means of an inertial platform or a suitable accelerometer. Such a measure makes it possible to determine the relative movement between the sensor and the object as well as the movement of the object itself and the data acquisition rate can be adjusted if necessary.

As further development of the invention it is intended that the number of individual data sets to be determined, in particular in cases of relative movements as results of rotational motion, be varied in dependence on the distance between the optical sensor and the object to be measured or a section thereof.

The method is implemented by means of a 3D camera with a chip such as a CCD chip, which is read out and the data subsequently are evaluated by means of an image processing system. Here, the chip is read out in dependence on the relative movement between the optical sensor and the object. In particular, the frame rate of the chip is varied in dependence on the relative speed between the sensor and the object. However, it is also possible to control the frame rate of the chip in dependence on the overlap region of successive images recorded by the chip.

The distance between the optical sensor and the object to be measured should be between 2 mm and 20 mm. Moreover, distances should be chosen so that the size of the measuring field is 10 mm×10 mm.

1. A generation of an aggregate data set of at least one section of an object, such as a jaw region, to determine at least one characteristic feature, such as shape and position, by combining individual data sets, which are determined by means of an optical sensor, such as a 3D camera, moving relative to the object, and an image processing system, whereby individual data sets of consecutive images of the object contain redundant data, which are matched to combine the individual data sets,
characterized in that
the number of individual data sets acquired per time interval are varied in dependence on the magnitude of the relative movement between the optical sensor and the object.

2. The generation of an aggregate data set of claim 1,
characterized in that
the individual data sets are acquired in a discontinuous manner.

3. The generation of an aggregate data set of claim 1 or 2,
characterized in that
the number of individual data sets per time interval is varied by closed-loop and/or open-loop control.

4. The generation of an aggregate data set of at least one of the preceding claims,
characterized in that
the number of individual data sets acquired per time interval is controlled in dependence on the number of redundant data of consecutive data sets.

5. The generation of an aggregate data set of at least one of the preceding claims,
characterized in that
the number of individual data sets to be acquired is managed in dependence on the relative speed between the object and the optical sensor.

6. The generation of an aggregate data set of at least one of the preceding claims,
characterized in that
in addition to the dependence of the number of individual data sets per time interval upon the relative movement between the optical sensor and the object, the movement of the object is taken into account.

7. The generation of an aggregate data set of at least one of the preceding claims,
characterized in that
the movement of the object is determined by means of an inertial platform.

8. The generation of an aggregate data set of at least one of the preceding claims,
characterized in that
the relative movement between the object and the optical sensor is determined by means of at least one accelerometer and/or at least one rotation sensor.

9. The generation of an aggregate data set of at least one of the preceding claims,
characterized in that
the relative movement between the object and the optical sensor is determined by means of an inertial platform.

10. The generation of an aggregate data set of at least one of the preceding claims,
characterized in that
the number of individual data sets to be determined is varied—in particular during relative movements resulting from rotational motion—in dependence on the distance between the optical sensor and the object to be measured or a section thereof.

11. The generation of an aggregate data set of at least one of the preceding claims,
characterized in that
data of the overlap region of two consecutive images recorded by the optical sensor is redundant data.

12. The generation of an aggregate data set of at least one of the preceding claims,
characterized in that
the object is imaged onto a chip, such as a CCD chip, of the optical sensor, such as a 3D camera, and that the chip is read out in dependence on the relative movement between the optical sensor and the object.

13. The generation of an aggregate data set of at least one of the preceding claims,
characterized in that
the frame rate of the chip is controlled in dependence on the relative speed between the sensor and the object.

14. The generation of an aggregate data set of at least one of the preceding claims,
characterized in that
the frame rate of the chip is controlled in dependence on the overlap region of consecutive images recorded by the chip.

15. The generation of an aggregate data set of at least one of the preceding claims,
characterized in that
the optical sensor is moved at a distance a from the object, with 2 mm≦a≦20 mm.

16. The generation of an aggregate data set of at least one of the preceding claims,
characterized in that
the optical sensor is positioned relative to the object in a manner so that a measuring field of 10 mm×10 mm is obtained.
